(19) United States
(12) Patent Application Publication
(10) Pub. No.: US 2026/0340202 A1
(43) Pub. Date: Oct. 29, 2026

(54) AUTOMATIC CHANNEL MANAGEMENT PDMA CONTROLLING DEVICE WITH ENCRYPTION CONTROL MODULE

(71) Applicant: NUVOTON TECHNOLOGY CORPORATION, HSINCHU CITY (TW)

(72) Inventor: HSU-HUNG WU, Zhubei City (TW)

(21) Appl. No.: 19/659,879

(22) Filed: Apr. 27, 2026

(30) Foreign Application Priority Data
Apr. 29, 2025 (TW) 114116184

(51) Int. Cl. G06F 21/78; H04L 9/06; H04L 9/08

(52) U.S. Cl. CPC G06F 21/78; H04L 9/0631; H04L 9/0869

(57) ABSTRACT

An automatic channel management peripheral direct memory access control device is applicable to at least one peripheral and includes at least one channel, an encryption control module, an embedded static random access memory, a peripheral request preprocessing module, and a channel control module. The encryption control module includes an encryption engine, a true random number generator (TRNG), and a key storage module. The embedded static random access memory stores a channel descriptor table of each channel and records transfer message and includes a block encryption storage space to implement block encryption and key management function. The peripheral request preprocessing module processes a request issued by the peripheral. The channel control module selects an appropriate channel to perform data transfer according to information provided by the peripheral request preprocessing module.

### CROSS-REFERENCE TO RELATED APPLICATION

This application claims the benefit of Taiwan Patent Application No. 114116184, filed on Apr. 29, 2025, in the Taiwan Intellectual Property Office, the disclosure of which is incorporated herein in its entirety by reference.

### BACKGROUND OF THE INVENTION

### 1. Field of the Invention

The present invention relates to an automatic channel management peripheral direct memory access (PDMA) control device having an encryption control module, and more particularly to an automatic channel management PDMA control device that automatically configures PDMA channel without software intervention and has a built-in encryption control module.

### 2. Description of the Related Art

FIG. 1 is a prior art design of a cryptographic accelerator. The cryptographic accelerator includes a pseudo random number generator (PRNG) 110, and supports various encryption algorithms, such as but not limited to Advanced Encryption Standard (AES), Data Encryption Standard/Triple Data Encryption Standard (DES/TDES), Secure Hash Algorithm (SHA), Hash-based Message Authentication Code (HMAC), and Elliptic Curve Cryptography (ECC) algorithms, and also provides a direct memory access (DMA) mode. In the cryptographic accelerator shown in FIG. 1, there is one DMA channel 112a used for the AES algorithm, and one DMA channel 112c used for SHA/HMAC. Once a program configures a DMA register 108, the movement of data between an encryption engine and a static random access memory (SRAM) is completely completed by the DMA automatically.

However, the architecture shown in FIG. 1 builds the DMA into the encryption engine, where the number of DMA channels is very small, and it is limited to moving data in the SRAM or a synchronous dynamic random access memory (SDRAM) and cannot be directly applied to a communication interface that requires encryption protection.

Therefore, there is an urgent need for a PDMA control device having an encryption control module and a method thereof, in which an encryption engine is built in a PDMA controller, which not only can automatically allocate channels according to the time that will be occupied by the current data transfer of each PDMA channel, but also can satisfy the requirement of implementing data encryption on all communication interface.

### SUMMARY OF THE INVENTION

An objective of the present invention is to provide an automatic channel management peripheral direct memory access (PDMA) control device having an encryption control module and applicable to at least one peripheral, and the automatic channel management peripheral PDMA control device comprises at least one channel, the encryption control module, an embedded static random access memory (SRAM), a peripheral request preprocessing module, and a channel control module. The encryption control module comprises an encryption engine, a true random number generator, and a key storage module. The embedded static random access memory is configured to store a channel descriptor table of each of the at least one channel, and to record at least one transfer message, and comprises a block encryption storage space, which is signally connected to the encryption control module and configured to implement block encryption and key management function. The peripheral request preprocessing module is configured to process a request issued by the at least one peripheral. The channel control module is configured to select a suitable one of the at least one channel to perform data transfer according to information provided by the peripheral request preprocessing module.

An objective of the present invention is to provide an automatic channel management peripheral direct memory access control method, applicable to at least one peripheral and comprising steps: setting an automatic channel management peripheral direct memory access control device having an encryption control module to enable one or more channels; starting a timer to record a start time of a transfer when the automatic channel management peripheral direct memory access control device receives a request issued by the at least one peripheral, obtaining a peripheral descriptor table configured to confirm a peripheral identifier and a transfer data amount, and estimating a next required transfer time according to a previous transfer time and a transfer data amount recorded in a record buffer; selecting and allocating the channel currently occupying a shortest transfer time to a next received request according to a number of incomplete requests, and updating the peripheral descriptor table into a channel descriptor table of the allocated channel; performing a data transfer, wherein during a process of waiting to perform the data transfer, timing of the timer is suspended, and the timing of the timer is continued when performing the data transfer; performing encryption control when an encryption algorithm is triggered, and achieving a hardware acceleration function of encryption and decryption through operations of an encryption engine, a true random number generator (TRNG), a key storage module, and a block encryption storage space in an embedded static random access memory (SRAM) built in the automatic channel management peripheral direct memory access control device; checking whether a next peripheral descriptor table is valid when one of the one or more channels completes the data transfer, and updating the transfer time to the record buffer; obtaining a next peripheral descriptor table of an available channel and performing the data transfer again when the next peripheral descriptor table exists validly; removing the peripheral descriptor table of the available channel and updating a transfer model when the next peripheral descriptor table does not exist, so as to complete the data transfer.

As derived from the above, the PDMA control device with the encryption control module provided by the present invention features a built-in encryption engine within the PDMA controller. In addition to automatically allocating channels based on the estimated data transfer time of each PDMA channel, it fulfills the requirement for data encryption across all communication interfaces.

### BRIEF DESCRIPTION OF THE DRAWINGS

The structure, operating principle and effects of the present invention will be described in detail by way of various embodiments which are illustrated in the accompanying drawings.

FIG. 1 is a prior art design of a cryptographic accelerator.

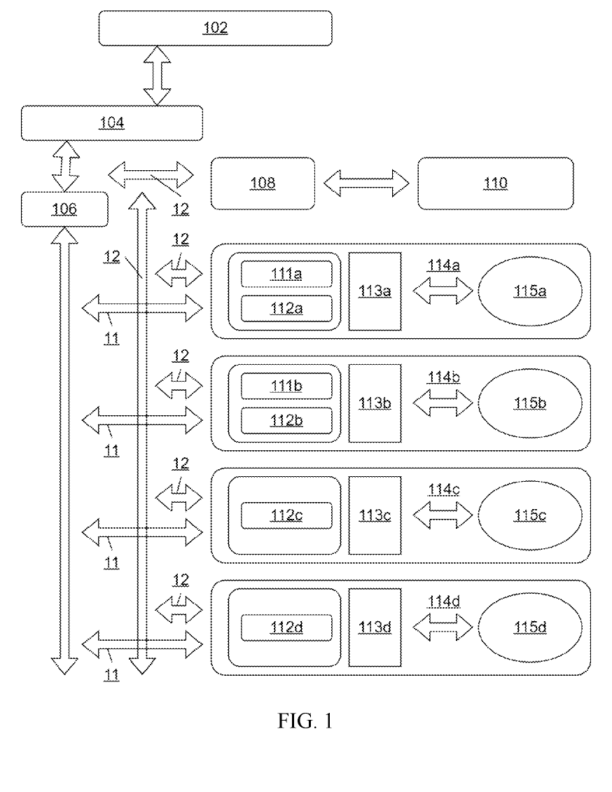

FIG. 2 is a device architecture diagram of an automatic channel management PDMA control device having an encryption control module according to an embodiment of the present invention.

FIG. 3 is an operation flow diagram of the automatic channel management PDMA control device having an encryption control module according to an embodiment of the present invention.

### DETAILED DESCRIPTION OF THE PREFERRED EMBODIMENTS

The following embodiments of the present invention are herein described in detail with reference to the accompanying drawings. These drawings show specific examples of the embodiments of the present invention. These embodiments are provided so that this disclosure will be thorough and complete, and will fully convey the scope of the invention to those skilled in the art. It is to be acknowledged that these embodiments are exemplary implementations and are not to be construed as limiting the scope of the present invention in any way. Further modifications to the disclosed embodiments, as well as other embodiments, are also included within the scope of the appended claims.

These embodiments are provided so that this disclosure is thorough and complete and fully conveys the inventive concept to those skilled in the art. Regarding the drawings, the relative proportions, and ratios of elements in the drawings may be exaggerated or diminished in size for the sake of clarity and convenience. Such arbitrary proportions are only illustrative and not limiting in any way. The same reference numbers are used in the drawings and descriptions to refer to the same or like parts. As used herein, the singular forms "a", "an" and "the" are intended to include the plural forms as well, unless the context clearly indicates otherwise.

It is to be acknowledged that, although the terms ‘first,’ ‘second,’ ‘third,’ and so on, may be used herein to describe various elements, these elements should not be limited by these terms. These terms are used only for the purpose of distinguishing one component from another component. Thus, a first element discussed herein could be termed a second element without altering the description of the present disclosure. As used herein, the term "or" includes any and all combinations of one or more of the associated listed items.

It will be acknowledged that when an element or layer is referred to as being "on," "connected to" or "coupled to" another element or layer, it can be directly on, connected or coupled to the other element or layer, or intervening elements or layers may be present. In contrast, when an element is referred to as being "directly on," "directly connected to" or "directly coupled to" another element or layer, there are no intervening elements or layers present.

In addition, unless explicitly described to the contrary, the words “comprise” and “include,” and variations such as “comprises,” “comprising,” “includes,” or “including,” will be acknowledged to imply the inclusion of stated elements but not the exclusion of any other elements.

In view of the above issues, the present invention provides a PDMA control device having an encryption control module. In the PDMA control device, an encryption engine is built in a PDMA controller, which not only can automatically allocate channels according to the time that will be occupied by the current data transfer of each PDMA channel, but also can satisfy the requirement of implementing data encryption on all communication interfaces.

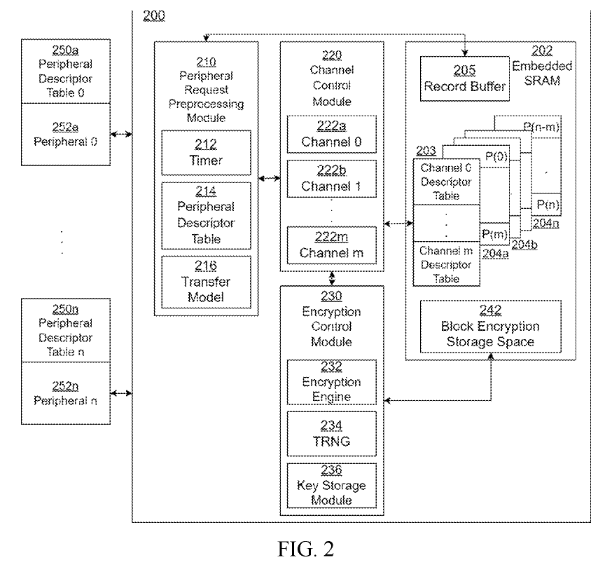

Please refer to FIG. 2. The present invention provides an automatic channel management PDMA control device 200 having an encryption control module, and the automatic channel management PDMA control device 200 comprises an embedded static random access memory (SRAM) 202 configured to store a channel descriptor table of each PDMA channel and record valid transfer message. In an embodiment having m channels and n peripherals (wherein the number of channels m is less than the number of peripherals n), the channel descriptor tables 203 of channel 0, channel 1, ..., channel m are respectively stored in the embedded SRAM 202. For n peripherals, peripheral descriptor tables 204a, 204b, ..., 204n are stored in the embedded SRAM 202, respectively storing a descriptor table of each peripheral for each channel. For example, the peripheral descriptor table 204a includes a descriptor table P(0) of peripheral 0 for channel 0, a descriptor table P(1) of peripheral 1 for channel 1, ..., a descriptor table P(m) of peripheral m for channel m; the peripheral descriptor table 204b includes a descriptor table P(m+1) of peripheral (m+1) for channel 0, a descriptor table P(m+2) of peripheral (m+2) for channel 1, ..., a descriptor table P(2m) of peripheral 2m for channel m, ..., and the peripheral descriptor table 204n includes a descriptor table P(n-m) of peripheral (n-m) for channel 0, a descriptor table P(n-m+1) of peripheral (n-m+1) for channel 1, ..., a descriptor table P(n) of peripheral n for channel m. The embedded SRAM 202 further includes a record buffer 205 configured to record valid transfer message, such as a peripheral identifier (ID), a transfer data amount, a transfer time, and the like.

The automatic channel management PDMA control device 200 further includes a peripheral request preprocessing module 210 configured to process a PDMA request issued by a peripheral. The peripheral request preprocessing module 210 includes a timer 212, a peripheral descriptor table 214, and a transfer model 216. When a request signal issued by a peripheral is received, the peripheral request preprocessing module 210 starts the timer 212 to record a transfer time. The timer 212 adopts hardware timing, so the transfer time can be recorded without baud rate (Baud) information of signal transfer. At the same time, the peripheral request preprocessing module 210 obtains a peripheral descriptor table 214 from the peripheral (for example, the peripheral descriptor table 0 250a of peripheral 0 252a, ..., the peripheral descriptor table n 250n of peripheral n 252n) configured to confirm a transfer type, a transfer data amount, and a peripheral identifier (ID), and whether an encryption and decryption operation is required. In the peripheral request preprocessing module 210, there is further a transfer model 216, which can estimate a next required transfer time according to a previous valid transfer record, including a transfer time and a transfer data amount.

The automatic channel management PDMA control device 200 further includes a channel control module 220 configured to select an appropriate PDMA channel (for example, channel 0 222a, channel 1 222b, ..., channel m 222m) to perform data transfer according to information provided by the peripheral request preprocessing module 210. When all channels are active, the channel control module 220 further can allocate the channel occupying a minimum transfer time to a newly received peripheral request according to a current pending transfer request, and update the peripheral descriptor table into the channel descriptor table of this allocated channel.

The automatic channel management PDMA control device 200 further includes an encryption control module 230, which provides an encryption engine 232, a true random number generator (TRNG) 234, and a key storage module 236. The encryption engine 232 supports various encryption algorithms, such as but not limited to Advanced Encryption Standard (AES), Data Encryption Standard/Triple Data Encryption Standard (DES/TDES), Secure Hash Algorithm (SHA), Hash-based Message Authentication Code (HMAC), and Elliptic Curve Cryptography (ECC) algorithms. The embedded SRAM 202 includes a block encryption storage space 242 signal-connected to the encryption control module 230 for implementing block encryption and key management function. By building the encryption control module into the PDMA control device and its internal embedded SRAM, requirements for implementing data encryption on all communication interface can be satisfied, while encryption principle and operation steps of the encryption engine 232, the true random number generator 234, the key storage module 236, and the block encryption storage space 242 are prior art and will not be further described herein.

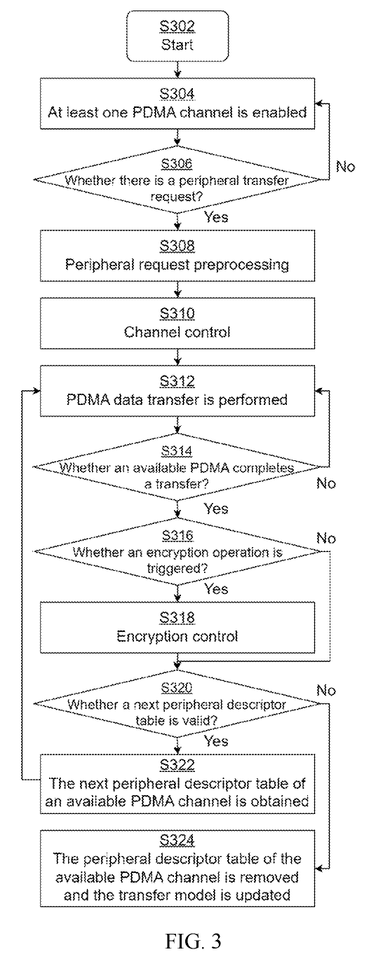

The present invention further provides a PDMA control method having an encryption control module, and the PDMA control method can automatically allocate channel according to time that will be occupied by current data transfer of each PDMA channel, and also satisfy requirements for implementing data encryption on all communication interface. Please refer to FIG. 3 and FIG. 2 together to understand an operational flow of the PDMA control method provided by the present invention in more detail.

First, in step S302, the flow starts.

Next, in step S304, the automatic channel management PDMA control device 200 having an encryption control module is set to enable one or more PDMA channel.

Subsequently, in step S306, the flow is divided into two paths according to whether there is a peripheral transfer request. If there is a peripheral transfer request, the flow enters step S308. If there is no peripheral transfer request, the flow returns to step S304.

In step S308, when the automatic channel management PDMA control device receives a peripheral transfer request signal issued by a peripheral, the peripheral request preprocessing module 210 starts the timer 212 to record a start time of a transfer, and the automatic channel management PDMA control device obtains the peripheral descriptor table 214 to confirm a peripheral identifier (ID) and a transfer data amount, and estimates a next required transfer time according to a previous transfer time and a transfer data amount recorded in the record buffer 205.

Subsequently, in step S310, the channel control module 220 selects the channel currently occupying a shortest transfer time to be allocated for a next received peripheral request according to one or more incomplete requests, while updating the peripheral descriptor table into the channel descriptor table of this selected channel.

Subsequently, in step S312, PDMA data transfer is performed. During a process of waiting for PDMA to perform data transfer, timing of the timer 212 is suspended, and the timing of the timer 212 is continued when performing data transfer.

Subsequently, in step S314, the flow is divided into two paths according to whether an available PDMA completes a transfer. If yes, the flow enters step S316. If no, the flow returns to step S312 to continue data transfer.

In step S316, after the PDMA completes one data transfer service, if an encryption operation is required, then at this time, data is temporarily stored in the block encryption storage space 242 in the embedded SRAM 202, and a hardware acceleration function of encryption and decryption is achieved through the encryption engine 232. If the encryption operation is not required, then whether a next peripheral descriptor table is valid is checked, and the transfer time is updated to the record buffer 205. The flow is divided into two paths according to whether an encryption algorithm (such as AES) is triggered. If yes, the flow enters step S318. If no, the flow enters step S320. It should be noted that, since the automatic channel management PDMA control device 200 provided by the present invention does not require software intervention in channel management, a determination of whether the encryption algorithm is triggered is decided according to whether there is a record of an encryption and decryption operation requirement for the data in a PDMA control register, which is not shown in FIG. 2.

In step S318, encryption control is performed, and the hardware acceleration function for encryption and decryption is achieved through operations of the encryption engine 232, the true random number generator 234, the key storage module 236 built in the automatic channel management PDMA control device 200, and the block encryption storage space 242 built in the embedded SRAM 202.

In step S320, when one channel completes data transfer, whether a next peripheral descriptor table is valid is checked, and the transfer time is updated to the record buffer 205. The flow is divided into two paths according to whether a next peripheral descriptor table exists validly. When a next peripheral descriptor table exists validly, the flow enters step S322. When a next peripheral descriptor table does not exist validly, the flow enters step S324.

In step S322, the next peripheral descriptor table of an available PDMA channel is obtained. Subsequently, the flow returns to step S312 to perform data transfer again.

In step S324, the peripheral descriptor table of the available PDMA channel is removed and the transfer model is updated, data transfer is completed, and the flow ends.

According to the above mentioned embodiment, the PDMA control device having an encryption control module provided by the present invention has the encryption engine built in the PDMA controller, which not only can automatically allocate channel according to the time that will be occupied by current data transfer of each PDMA channel, but also can satisfy requirements for implementing data encryption on all communication interface.

The present invention disclosed herein has been described by means of specific embodiments. However, numerous modifications, variations and enhancements can be made thereto by those skilled in the art without departing from the spirit and scope of the disclosure set forth in the claims.

What is claimed is:

1. An automatic channel management peripheral direct memory access control device having an encryption control module and applicable to at least one peripheral, comprising:
at least one channel;
the encryption control module, comprising an encryption engine, a true random number generator, and a key storage module;
an embedded static random access memory, configured to store a channel descriptor table of each of the at least one channel, and to record at least one transfer message, and comprising a block encryption storage space, which is signally connected to the encryption control module and configured to implement block encryption and key management function;
a peripheral request preprocessing module, configured to process a request issued by the at least one peripheral; and
a channel control module, configured to select a suitable one of the at least one channel to perform data transfer according to information provided by the peripheral request preprocessing module.

2. The automatic channel management peripheral direct memory access control device as claimed in claim 1, wherein, for each of the at least one peripheral, a peripheral descriptor table is stored in the embedded static random access memory and configured to store a descriptor table of each of the at least one peripheral for each of the at least one channel.

3. The automatic channel management peripheral direct memory access control device as claimed in claim 1, wherein the embedded static random access memory comprises a record buffer configured to record the at least one transfer message.

4. The automatic channel management peripheral direct memory access control device as claimed in claim 3, wherein the at least one transfer message comprises at least one of a peripheral identifier, a transfer data amount, and a transfer time.

5. The automatic channel management peripheral direct memory access control device as claimed in claim 1, wherein the peripheral request preprocessing module comprises a timer, and upon receiving the request issued by the peripheral, the peripheral request preprocessing module starts the timer to record a transfer time.

6. The automatic channel management peripheral direct memory access control device as claimed in claim 1, wherein the peripheral request preprocessing module obtains at least one peripheral descriptor table from the at least one peripheral to confirm a transfer type, a transfer data amount, a peripheral identifier, and whether an encryption and decryption operation is required.

7. The automatic channel management peripheral direct memory access control device as claimed in claim 1, wherein the peripheral request preprocessing module comprises a transfer model, configured to estimate a second transfer time according to a previous transfer record, and the previous transfer record comprises a first transfer time and a transfer data amount.

8. The automatic channel management peripheral direct memory access control device as claimed in claim 1, wherein when each of the at least one channel is available, the channel control module allocates the channel occupying a minimum transfer time to a newly received request according to a current pending request, and updates a peripheral descriptor table into a channel descriptor table of the allocated channel.

9. The automatic channel management peripheral direct memory access control device as claimed in claim 1, wherein algorithms supported by the encryption engine comprise at least one of Advanced Encryption Standard (AES), Data Encryption Standard/Triple Data Encryption Standard (DES/TDES), Secure Hash Algorithm (SHA), Hash-based Message Authentication Code (HMAC), and Elliptic Curve Cryptography (ECC) algorithm.

10. An automatic channel management peripheral direct memory access control method, applicable to at least one peripheral and comprising:
setting an automatic channel management peripheral direct memory access control device having an encryption control module to enable one or more channels;
starting a timer to record a start time of a transfer when the automatic channel management peripheral direct memory access control device receives a request issued by the at least one peripheral, obtaining a peripheral descriptor table configured to confirm a peripheral identifier and a transfer data amount, and estimating a next required transfer time according to a previous transfer time and a transfer data amount recorded in a record buffer;
selecting and allocating the channel currently occupying a shortest transfer time to a next received request according to a number of incomplete requests, and updating the peripheral descriptor table into a channel descriptor table of the allocated channel;
performing a data transfer, wherein during a process of waiting to perform the data transfer, timing of the timer is suspended, and the timing of the timer is continued when performing the data transfer;
performing encryption control when an encryption algorithm is triggered, and achieving a hardware acceleration function of encryption and decryption through operations of an encryption engine, a true random number generator (TRNG), a key storage module, and a block encryption storage space in an embedded static random access memory (SRAM) built in the automatic channel management peripheral direct memory access control device;
checking whether a next peripheral descriptor table is valid when one of the one or more channels completes the data transfer, and updating the transfer time to the record buffer;
obtaining a next peripheral descriptor table of an available channel and performing the data transfer again when the next peripheral descriptor table exists validly; and
removing the peripheral descriptor table of the available channel and updating a transfer model when the next peripheral descriptor table does not exist, so as to complete the data transfer.
